(19) United States
(12) Patent Application Publication
(10) Pub. No.: US 2022/0281253 A1
(43) Pub. Date: Sep. 8, 2022

(54) ADDITIVE OPTO-THERMOMECHANICAL NANOPRINTING AND NANOREPAIRING UNDER AMBIENT CONDITIONS

(71) Applicant: University of Dayton Research Institute, Dayton, OH (US)

(72) Inventors: Md Shah Alam, Dayton, OH (US); Qiwen Zhan, Dayton, OH (US); Chenglong Zhao, Dayton, OH (US)

(21) Appl. No.: 17/688,517

(22) Filed: Mar. 7, 2022

Related U.S. Application Data
(60) Provisional application No. 63/157,808, filed on Mar. 7, 2021.

(51) Int. Cl. B41M 5/035; B23K 26/342; B23K 26/08

(52) U.S. Cl. CPC B41M 5/035; B23K 26/342; B23K 26/083; B23K 2101/34

(57) ABSTRACT

An opto-thermomechanical (OTM) nanoprinting method allows for additively printing nanostructures with sub-100 nanometer accuracy and for correcting printing errors for nanorepairing under ambient conditions. Different from other existing nanoprinting methods, this method works when a nanoparticle on the surface of a soft substrate is illuminated by a continuous-wave (CW) laser beam in a gaseous environment. The laser heats the nanoparticle and induces a rapid thermal expansion of the soft substrate. This thermal expansion can either release a nanoparticle from the soft surface for nanorepairing or transfer it additively to another surface in the presence of optical forces for nanoprinting with sub-100 nm accuracy. This additive OTM nanoprinting technique paves the way for rapid and affordable additive manufacturing or 3D printing at the nanoscale under ambient conditions.

### CROSS REFERENCE TO RELATED APPLICATIONS

This application claims the benefit of U.S. Provisional Patent Application Ser. No. 63/157,808, filed Mar. 7, 2021, having the title ADDITIVE OPTO-THERMOMECHANICAL NANOPRINTING AND NANOREPAIRING UNDER AMBIENT CONDITIONS, the disclosure of which is hereby incorporated herein by reference.

### BACKGROUND

Various aspects of the present invention relate generally to nanoprinting and nanoreparing and more specifically to nanoprinting and nanoreparing under ambient conditions using a laser.

Three-dimensional (3D) printing or additive manufacturing, which forms structures by adding materials layer upon layer, has attracted increasing attention due to its wide range of applications in various fields such as energy, batteries, structural electronics, optoelectronics, metamaterial, robotics, microfluidics, healthcare, and drug delivery. Lasers have been widely used in 3D printing for rapid prototyping at the macro- and microscales due to their excellent directivity for efficient energy delivery to the targeted materials. For example, microsized metallic particles can be selectively melted or sintered by a high-power laser beam to form complex 3D metal parts. However, it is challenging to directly downsize the existing macro- and microscale 3D printing techniques for nanoscale printing or nanoprinting. Nanoparticles are ideal for serving as the raw materials for nanoprinting either in a liquid or a gaseous environment due to their custom-designed large-volume and low-cost production with unique physical and chemical properties. Nanoparticles can be attached to each other through electrostatic or van der Waals forces once they are in contact with each other. Therefore, 3D nanoprinting at the nanoscales can be realized by precisely manipulating and assembling individual nanoparticles to form the final structures.

Template-assisted methods, such as selective surface patterning and capillary assembly, have been used for 2D patterning of nanoparticles but requires multiple steps. Optical printing based on optical forces has been able to immobilize individual colloidal nanoparticles onto a substrate, but with printing accuracy fundamentally limited by the Brownian motion of nanoparticles in a liquid environment and also limited to 2D manufacturing due to thermophoretic force. Laser-induced forward/backward transfer (LIFT/LIBT) techniques can be used to print 2D and 3D structures in a gaseous environment, but pulsed lasers have to be used.

Electrohydrodynamic printing technique has the ability to print 3D nanostructures using nanoparticle solution as ink but lacks the capability of individual nanoparticle control and requires a conductive surface to work with.

### BRIEF SUMMARY

According to various aspects of the present disclosure, an additive opto-thermomechanical nanoprinting (OTM-NP) technique is provided, which overcomes the aforementioned limitations for 3D printing on a nanoscale. The working mechanism and the parameters that affect the printing accuracy are discussed in greater detail herein. However, in summary, the OTM-NP has at least the following unique features: (1) both dielectric and metallic nanoparticles can be printed onto any type of substrate; (2) printing errors can be corrected; (3) a continuous-wave (CW) laser is used instead of a pulsed laser; and (4) both nanoprinting and nanorepairing are conducted in the air and thus can avoid potential contaminations in a liquid environment.

### BRIEF DESCRIPTION OF THE SEVERAL VIEWS OF THE DRAWINGS

FIG. 1A is a schematic of opto-thermomechanical nanoprinting (OTM-NP), according to various aspects of the present disclosure;

FIG. 1B is a photograph of a donor substrate with three 100-nanometer (nm) AuNPs (gold nanoparticles), where an AuNP circled in red will be released from the donor substrate, according to various aspects of the present disclosure;

FIG. 1C is a photograph of the donor substrate of FIG. 1B after one of the AuNPs has been released, according to various aspects of the present disclosure;

FIG. 1D is a photograph of a receiver substrate with the AuNP of the donor substrate of FIGS. 1B-C, according to various aspects of the present disclosure;

FIG. 1E is an optical image of additive printing of one, two, three, and four individual 100-nm AuNPs on a receiver substrate, according to various aspects of the present disclosure;

FIG. 1F is a scanning electron microscope (SEM) image of additive printing of one, two, three, and four individual 100-nm AuNPs on a receiver substrate, according to various aspects of the present disclosure;

FIG. 1G is a finite element method (FEM) simulation of temperature distribution and thermal expansion of the PDMS substrate for a 100 nm AuNP under laser illumination, according to various aspects of the present disclosure;

FIG. 2A is a photograph of 100-nm AuNPs on a Polydimethylsiloxane (PDMS) donor substrate, where the inlay bar represents 1000 nm), according to various aspects of the present disclosure;

FIG. 2B is a photograph of 200-nm AuNPs on a Polydimethylsiloxane (PDMS) donor substrate, where the inlay bar represents 1000 nm), according to various aspects of the present disclosure;

FIG. 3 is an experimental setup for OTM-NP, according to various aspects of the present disclosure;

FIGS. 4A-F are illustrations of the OTM-NP process, where arrows illustrate forces acting upon an AuNP, according to various aspects of the present disclosure;

FIG. 4A illustrates an AuNP attached to a surface of a donor substrate due to van der Waals attraction force, according to various aspects of the present disclosure;

FIG. 4B illustrates a thermal expansion force applied to the AuNP due to thermal expansion of the substrate after the laser is turned on as a focused beam from the laser also exerts an optical axial force and optical gradient force to the AuNP, according to various aspects of the present disclosure;

FIG. 4C illustrates that the AuNP acquires enough momentum, overcomes the van der Waals force, and starts to move toward the very closely placed (˜1 μm gap) receiver substrate in the presence of optical axial force and optical gradient force, while a drag force opposes the motion of the AuNP, according to various aspects of the present disclosure;

FIG. 4D illustrates that the direction of the optical axial force flips when the AuNP is a few hundred nanometers away from a center of the focus, according to various aspects of the present disclosure;

FIG. 4E illustrates that a receiver substrate attracts the AuNP when it reaches close to the receiver substrate, according to various aspects of the present disclosure;

FIG. 4F illustrates that the AuNP reaches the receiver substrate and is printed on it due to van der Waals attraction force, according to various aspects of the present disclosure;

FIG. 5A is a graph illustrating a simulated (FEM) temperature of a 200 nm AuNP on a PDMS substrate as a function of time (solid line); the dashed line represents assumed per unit laser intensity vs time (LCOS (liquid crystal on silicon) switching), considering a one-pecond switching time of the LCOS with a laser intensity of 20 mW/μm², according to various aspects of the present disclosure;

FIG. 5B is a graph illustrating a simulated (FEM) thermal expansion rate of the AuNP of FIG. 5A, according to various aspects of the present disclosure;

FIGS. 6A-B illustrate an AuNP not being released from a substrate, according to various aspects of the present disclosure;

FIGS. 7A-C illustrate a silica nanoparticle printing from indium tin-oxide-coated polyethylene terephthalate (PET) substrate, according to various aspects of the present disclosure;

FIG. 8A illustrates a 10×10 array of 100-nm AuNP printed on a glass substrate (scale bar is 100 nm), according to various aspects of the present disclosure;

FIG. 8B illustrates a scatter plot of printing error of OTM-NP in an x-y plane, according to various aspects of the present disclosure;

FIG. 8C illustrates x, y, and radial (r) cumulative distribution function of the printing error, according to various aspects of the present disclosure;

FIGS. 9A-C illustrate asymmetric thermal expansion of the donor substrate around the AuNP due to inhomogeneity of donor substrate (bar represents 1000 nm), according to various aspects of the present disclosure;

FIG. 9B illustrates asymmetric thermal expansion of the donor substrate when a laser is activated, according to various aspects of the present disclosure;

FIG. 9C illustrates asymmetric thermal expansion of the donor substrate after enough power is applied to desorb an AuNP particle, according to various aspects of the present disclosure;

FIG. 10A is a FEM simulation of temperature distribution and thermal expansion of a PDMS substrate showing an effect of inhomogeneity of the donor substrate (bar represents 500 nm), according to various aspects of the present disclosure;

FIG. 10B is a FEM simulation of temperature distribution and thermal expansion of a PDMS substrate showing an effect of particle shape (bar represents 500 nm), according to various aspects of the present disclosure;

FIGS. 10C-E are graphs illustrating positions of nanoparticles based on forces, according to various aspects of the present disclosure;

FIG. 10F is a graph illustrating van der Waals attractive force on particles, according to various aspects of the present disclosure;

FIG. 11A-B illustrate particle shape and an effect of preheating on imperfect spherical AuNP, according to various aspects of the present disclosure; and

FIG. 12A-F are optical and SEM images of additive nanoprinting and nanoreparing, according to various aspects of the present disclosure.

### DETAILED DESCRIPTION

According to various aspects of the present disclosure, an additive opto-thermomechanical nanoprinting (OTM-NP) technique is disclosed, which has the potential to overcome the aforementioned limitations for 3D printing on a nanoscale.

The working mechanism and the parameters that affect the printing accuracy are discussed in detail below. However, by way of brief introduction, the OTM-NP has advantages over existing solutions: (1) both dielectric and metallic nanoparticles can be printed onto any type of substrate; (2) printing errors can be corrected; (3) a continuous-wave (CW) laser is used instead of a pulsed laser; and (4) both nanoprinting and nanorepairing are conducted in air (as opposed to a liquid environment) and can thus avoid potential contaminations and accuracy issues that may occur in a liquid environment.

In this regard, according to aspects herein, an opto-thermomechanical transfer technology is provided, which allows for the selective transfer of a single-nanoparticle (any type) from a donor surface to any other surfaces. The trajectory of the nanoparticle in the transfer process can be precisely controlled with accuracy better than 100 nm.

Aspects herein enable various applications, such as the ability to transfer a single nanoparticle in a mass spectrometer for single particle analysis. Another example application is for additive manufacturing of 3D nanostructures for nano-sensing, quantum sensing, metasurfaces, etc. Yet further, applications include the repair of manufacturing errors in 3D nanoprinting, loading an exact number of nanoparticles in a liquid container to develop nanoparticle count reference, to transfer nanoparticle between different substrate for nanoparticle characterization, to transfer nanoparticle to bio-samples for nanoparticle toxicity assessment, etc.

Moreover, aspects herein provide several advantages over other processes, such as laser-induced forward/backward transfer (LIFT/LIBT) and blister-based laser-induced forward transfer (BB-LIFT). For instance, a femtosecond (fs) or nanosecond (ns) pulsed laser is used in the BB-LIFT method, whereas a continuous-wave (CW) laser can be used according to aspects of the present disclosure. Also, an absorptive/metal film is used in the BB-LIFT, whereas a transparent soft substrate (PDMS on glass) can be used according to aspects of the present disclosure. Still further, the required laser intensity to release nanoparticles as set out herein is lower than that with BB-LIFT. The heat affected zone (HAZ) according to aspects herein, is smaller than that in BB-LIFT. Moreover, the center of thermal expansion in BB-LIFT is located at the center of the incident laser beam on the substrate, whereas the peak position of the thermal expansion of the substrate, according to aspects herein, is located at the contact point of the absorptive nanoparticle and the substrate, which helps to release the nanoparticle normal to the donor substrate. Therefore, aspects herein can print a single nanoparticle with nanoscale accuracy.

Notably, the LIFT/LIBT requires an expensive pulsed laser, while aspects herein can be implemented using a low-cost contentious-wave laser. The printing accuracy of the additive OTM-NP method, disclosed herein, is affected by the parameters such as the homogeneity of donor substrate, nanoparticle shape, laser polarization, optical force, and the gap between the donor and receiver substrates. In comparison, the printing accuracy of the LIFT/LIBT is affected by parameters such as film thickness, laser focal spot size, laser pulse energy, and laser wavelength. In addition, the size of the printed nanoparticles with LIFT/LIBT is comparatively larger than that according to aspects of the present disclosure, because the HAZ in LIFT/LIBT depends on the size of the diffraction-limited laser focal spot. In contrast, the HAZ herein depends on the size of the AuNP, which can be smaller than that in LIFT/LIBT.

According to aspects herein, an opto-thermomechanical (OTM) nanoprinting method is provided that allows not only to additively print nanostructures with sub-100 nm accuracy but also to correct printing errors for nanorepairing under ambient conditions. Different from other existing nanoprinting methods, this method works when a nanoparticle on the surface of a soft substrate is illuminated by a continuous-wave (CW) laser beam in a gaseous environment. The laser heats the nanoparticle and induces a rapid thermal expansion of the soft substrate. This thermal expansion can either release a nanoparticle from the soft surface for nanorepairing or transfer it additively to another surface in the presence of optical forces for nanoprinting with sub-100 nm accuracy. This additive OTM nanoprinting technique can thus pave the way for rapid and affordable additive manufacturing or 3D printing at the nanoscale under ambient conditions.

### INTRODUCTION

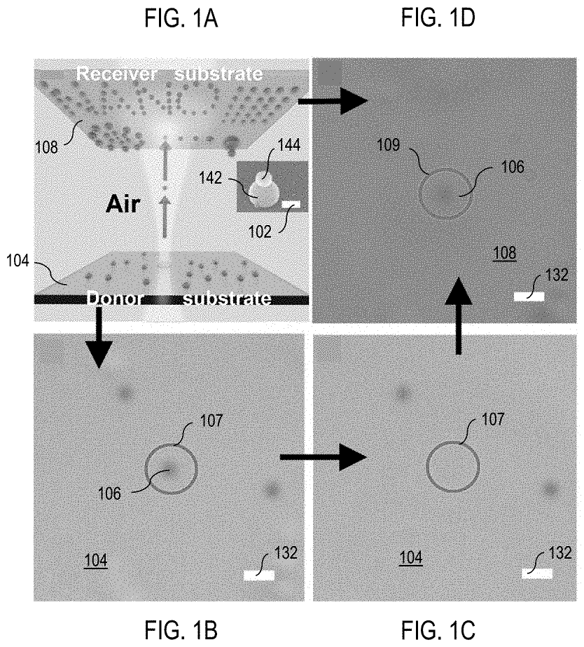

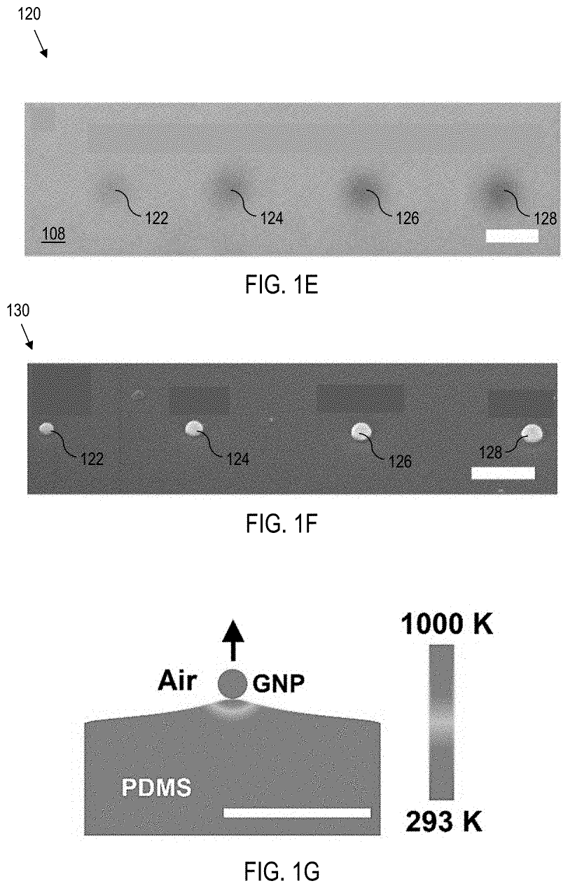

Referring now to the figures, and generally with reference to FIG. 1A-FIG. 1G, an example of OTM-NP process is shown. In summary, FIG. 1A illustrates a schematic of the OTM-NP process where an inlay bar 102 in FIG. 1A represents one-hundred-and-fifty nanometers (nm).

FIG. 1B illustrates three 100 nm AuNPs on a PDMS donor substrate 104. The AuNP 106 in a first circle 107 will be released from the donor substrate 104.

FIG. 1C illustrates that the AuNP in the first circle 107 is released from donor substrate 104 after a continuous wave laser is activated (i.e., the AuNP disappeared from the first circle 107).

FIG. 1D illustrates that the released AuNP 106 is transferred to a receiver substrate 108, as shown in a second circle 109.

FIG. 1E is an optical image 120 of additive printing of four individual 100 nm AuNPs 122, 124, 126, 128 at a similar position on the receiver substrate 108, respectively.

FIG. 1F is a scanning electron microscope (SEM) image 130 of additive printing of four individual 100 nm AuNPs 122, 124, 126, 128 at a same position on the receiver substrate 108, respectively.

FIG. 1G is a FEM simulation of temperature distribution and thermal expansion of the PDMS substrate for a 100 nm AuNP under laser illumination. Scale bars represent 500 nm.

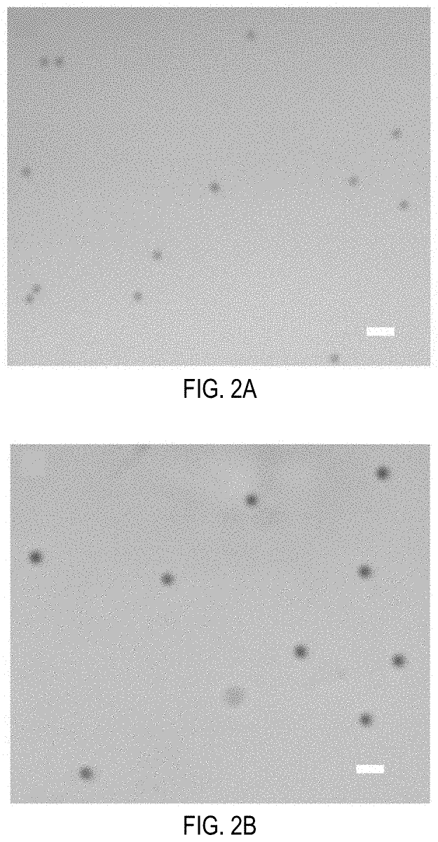

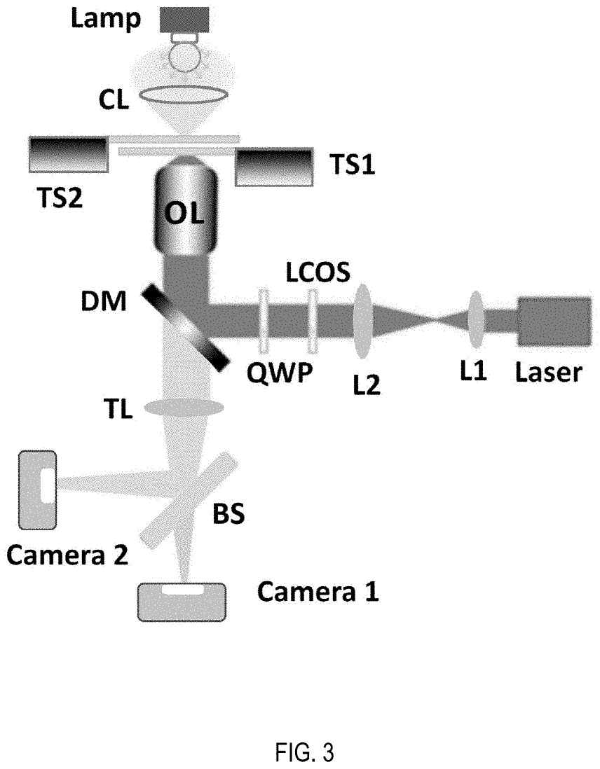

Referring to FIG. 1A, a gold nanoparticle solution is diluted, then drop-casted, and naturally dried on a donor substrate 104 comprising a soft, thin layer of polydimethylsiloxane (PDMS) on a glass coverslip. FIG. 2A shows dispersed gold nanoparticles (AuNPs) on the donor substrates. A continuous-wave laser (not shown) operating at a 1064 nm wavelength and including an oil-immersion objective to focus a laser beam emitted from the CW laser are used in an embodiment of the OTM-NP method. An optical setup for several embodiments of the method is shown in FIG. 3 and includes two lenses (L1 and L2), a liquid crystal optical shutter (LCOS); a quarter wave plate (QWP); a dichroic mirror (DM); an objective lens (OL); two Piezo-Translational stages (TS1 and TS2); a condenser lens (CL); a tube lens (TL); and a beam splitter (BS). A targeted 100 nm AuNP, as shown in the circle of FIG. 1B (inset bar 132 for FIGS. 1B-G represent 500 nm), is brought to the laser focus by using a nanopositioning stage, while the laser is not emitting a laser beam. When the laser is activated and emits a laser beam, the AuNP 106 is released from the donor substrate 104 (FIG. 1C). The released nanoparticle 106 is eventually transferred and printed onto a receiver substrate 108 (FIG. 1D) placed very close to the donor substrate 104.

In FIGS. 1E-F, individual AuNPs 122, 124, 126, 128 can be released in sequence and transferred additively onto a receiver substrate. FIG. 1E-F show the optical and SEM images of additive printing of four individual 100 nm AuNPs 122, 124, 126, 128 at a similar position on a glass substrate. The AuNPs are printed on top of prior-printed AuNPs and merged together to form a larger particle, depending on a number of AuNPs printed. Volumes of the resultant particles are directly proportional to the number of particles printed on the same positions of the receiver substrate. In some embodiments of the method, a laser intensity of 100 mW/μm2 was used to release and print the 100 nm AuNPs. It is further possible to control the laser intensity so that later-printed (i.e., subsequent) AuNPs are printed on top of prior-printed AuNP(s) rather than merged together. The inset in FIG. 1A shows such a structure by additively printing ten individual 150 nm AuNPs. The first nine AuNPs merge to form a base particle 142, and a tenth AuNP 144 lands on top of it.

The OTM-NP involves basic light-matter interaction along with thermomechanical behaviors of the substrate, particle-surface interaction, and particle dynamics. Polymer materials (e.g., PDMS) are highly flexible, are highly elastic, and have comparatively large linear thermal expansion coefficients (e.g., 3.2×10⁻⁴° C.⁻¹ for PDMS), which can provide significant thermal expansion force near their surfaces when exposed to a sudden temperature change due to the laser heating the AuNPs, as shown in the finite element method (FEM) simulation (FIG. 1G).

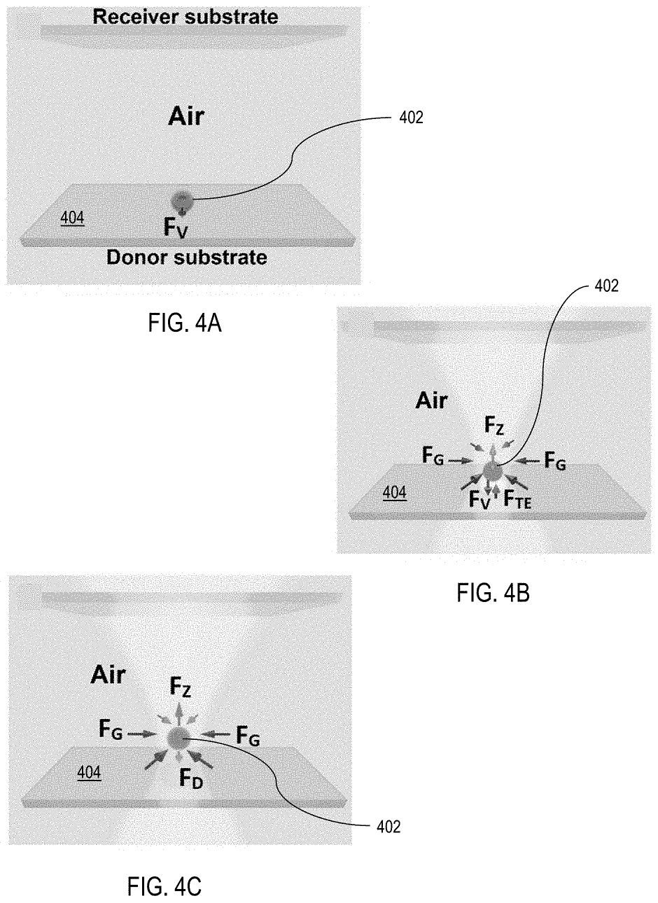

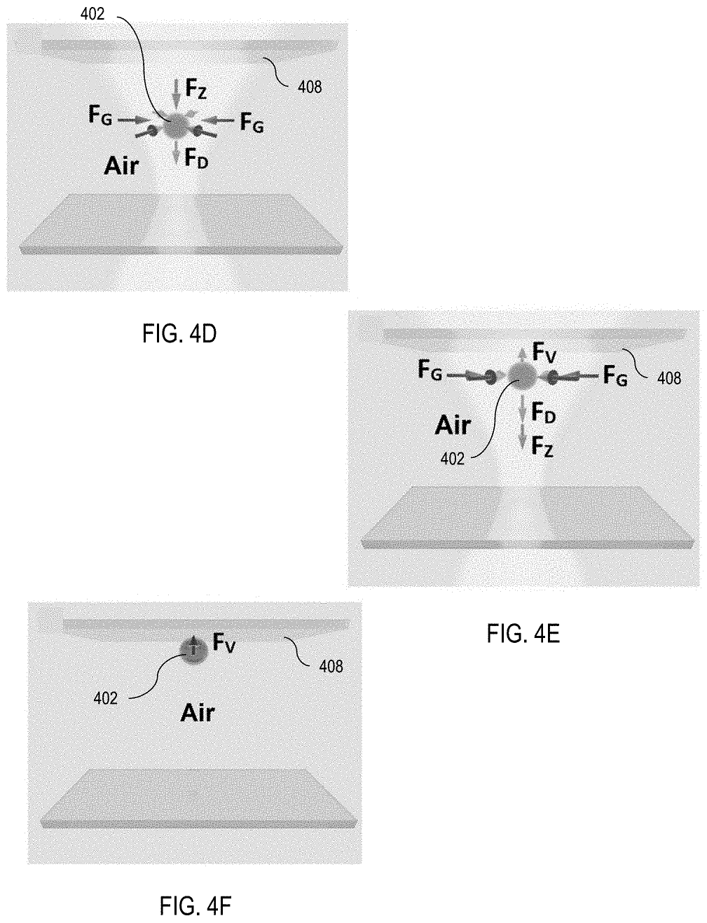

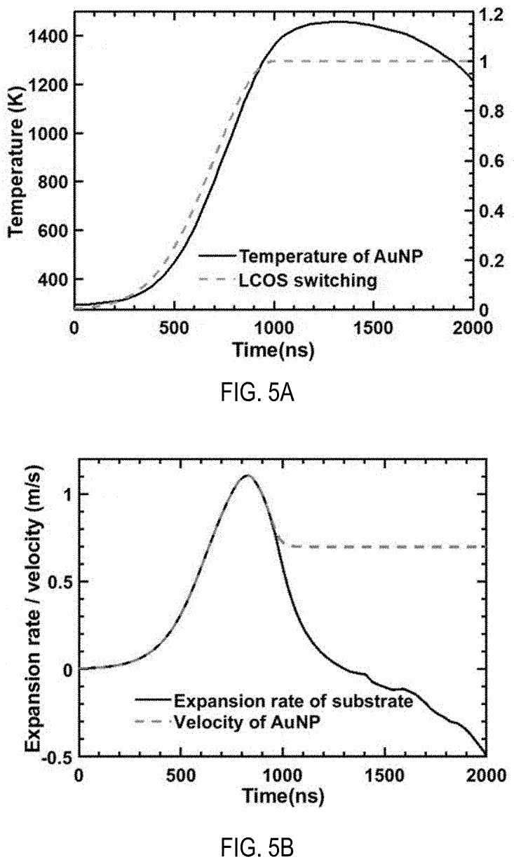

Turning now to FIGS. 4A-F, the method for OTM-NP is shown graphically with indication of forces involved. A metallic nanoparticle (e.g., AuNP) attaches to a surface of a donor substrate 404 (e.g., PDMS) by van der Waals attractive force (Fv) after the nanoparticle is dried in the air (FIG. 4A). The gravitational force on the AuNP is negligible (e.g., six orders of magnitude smaller than the van der Waals force). When the AuNP 402 is illuminated by a focused laser beam (see FIG. 4B), the nanoparticle 402 absorbs energy from the focused laser beam and heats the donor substrate 404, which causes rapid thermal expansion of the donor substrate 404. The thermal expansion rate of the substrate depends on the thermal expansion coefficient of the substrate material and the applied laser intensity. The rapid thermal expansion of the PDMS surface applies a thermal expansion force (F_{TE}). The AuNP 402 also experiences an optical axial force (Fz) and an optical gradient force (F_{G}) due to the focused laser beam. Here, the optical axial force Fz is the total force including an optical scattering force and gradient force in the laser propagating direction. However, the optical forces are negligible at the beginning of the process as the van der Waals force is around two orders of magnitude larger than the optical forces. In early stages of the surface deformation, the nanoparticle 402 moves together with the expanding substrate (FIG. 4B). Before reaching a steady state temperature, the velocity of the nanoparticle continues rising with the increasing expansion rate of the substrate 404 (see FIG. 5A-B). Eventually, the thermal expansion rate of the substrate 404, as well as the velocity of the AuNP 402, reaches their peaks (see, around 800 ns in FIG. 5B). Then, the thermal expansion rate of the substrate starts to decrease, which reduces the velocity of the AuNP 402 due to the van der Waals attraction force. However, the AuNP 402 tends to move upward at a constant velocity due to inertia (as shown in the chart FIG. 5B). As a result, an inertial force is applied to the AuNP. At a certain point, the thermal expansion rate of the substrate is low enough compared to the gained momentum of the AuNP such that the inertial force exceeds the van der Waals attraction force. Therefore, as seen in FIG. 4C, the AuNP 402 is released from the donor substrate 404 and moves upward in the presence of optical forces.

The AuNP 402 continues moving toward the very closely placed receiver substrate due to the inertia and the optical axial force Fz, as illustrated in FIG. 4C. The transverse optical gradient force (F_{G}) helps to push the AuNP 402 toward the optical axis and improves the printing accuracy. The laser is focused a few hundreds of nanometers above the AuNP when the AuNP is resting the donor substrate 404. Therefore, the optical axial force (Fz) on the AuNP is first upward (FIG. 4C), assisting in the AuNP release process and then changes its direction to downward (FIG. 4D). The air drag force (FD) on the AuNP always opposes the AuNP motion and slows down the AuNP. However, the AuNP keeps moving toward the receiver substrate due to the inertia. The temperature of the AuNP and the substrate drop after the AuNP is released from the donor substrate 404 (as shown in FIG. 5A) because the AuNP moves away from the laser focus which causes the shrinking of the donor substrate, and the donor substrate finally returns to its normal state due to its high elasticity. As the AuNP 402 approaches the receiver substrate 408, the van der Waals force between the AuNP and the receiver substrate becomes significant. Therefore, the AuNP is attracted toward the receiver substrate 408 (FIG. 4E) and finally printed onto it (FIG. 4F).

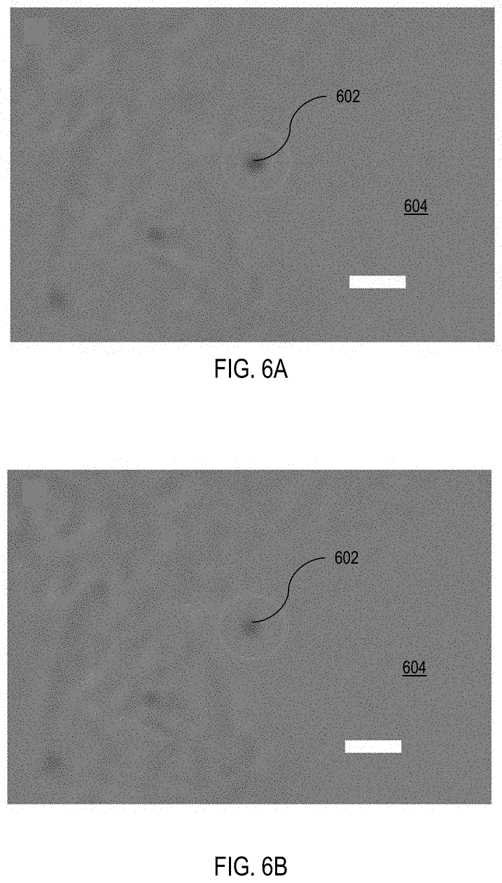

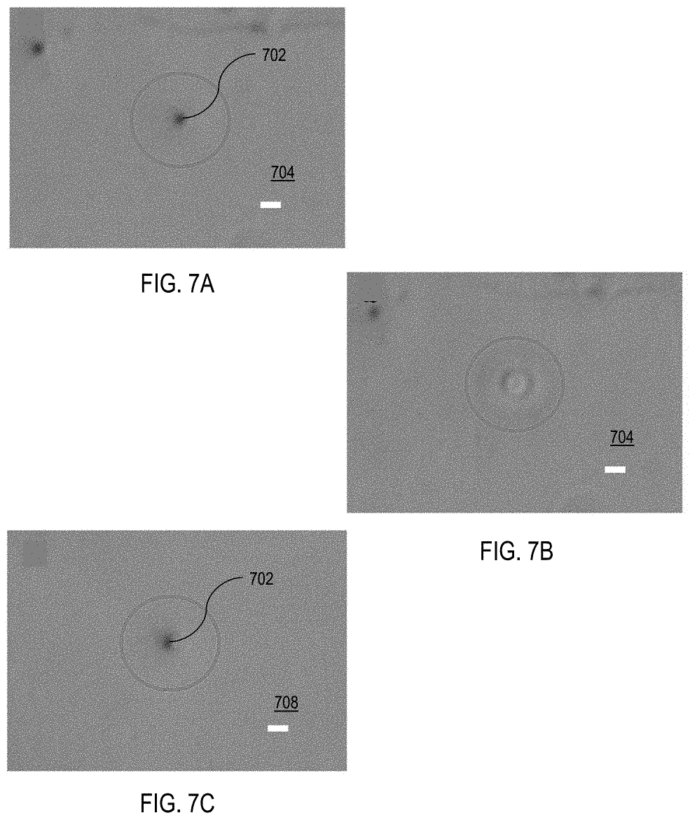

The AuNP can desorb from a flexible donor substrate but cannot desorb from a hard substrate, such as a glass substrate (FIG. 6A-B), due to the relatively small linear thermal expansion coefficient of the glass, 7.6×10⁻⁶ C⁻¹. Note that the AuNP 602 in FIG. 6A remains on the donor substrate (i.e., donor plate) of glass (a non-flexible substrate) 604 after a laser is activated, where FIG. 6B shows the AuNP remaining on the donor substrate 604. Therefore, the material of the donor substrate plays an important role in the OTM-NP, and the proper choice of the donor substrate depends on the optical property of the nanoparticles to be printed. The following guidelines can be used for the choice of the donor substrate: if the nanoparticles to be printed are absorptive to the laser (such as AuNPs), a transparent and flexible substrate (such as the PDMS) can be used as the donor substrate; or if the nanoparticles are transparent to the laser (such as dielectric nanoparticles), an absorptive substrate can be used as the donor substrate. FIG. 7A-C shows the printing of dielectric silica (SiO₂) nanoparticles 702 from an indium tin oxide (ITO)-coated polyethylene terephthalate (PET) donor substrate 704. Here, ITO absorbs the laser energy and causes thermal expansion of PET. FIG. 7C shows a receiving substrate 708 upon which the SiO₂ nanoparticle 702 from the donor substrate is printed.

A similar technique, blister-based laser-induced forward transfer (BB-LIFT), has been demonstrated to release particles or liquid ink from an absorbing/metal film by using pulsed lasers as a result of thermal expansion/deformation of the substrate. However, the OTM-NP has several different features compared to the BB-LIFT. For example, a fs (femtosecond) or ns (nanosecond) pulsed laser is used in the BB-LIFT method, while a continuous-wave (CW) laser is used in the OTM-NP. As another example, an absorptive/metal film is used in the BB-LIFT, while a transparent soft substrate (PDMS on glass) is used in the OTM-NP of absorptive nanoparticles. A further difference includes that the required laser intensity to release nanoparticles with OTM-NP is five orders of magnitude lower than that with BB-LIFT. Moreover, as the substrate is transparent and the metal nanoparticle is responsible for generating heat by laser absorption, the size of the heat affected zone (HAZ) in OTM-NP is smaller than that in BB-LIFT. Also, the center of thermal expansion in BB-LIFT is located at the center of the incident laser beam on the substrate, while the peak position of the thermal expansion of the substrate in OTM-NP is located at the contact point of the absorptive nanoparticle and the substrate, which helps to release the nanoparticle normal to the donor substrate (FIG. 1G). Therefore, the OTM-NP technique can print a single nanoparticle with nanoscale accuracy.

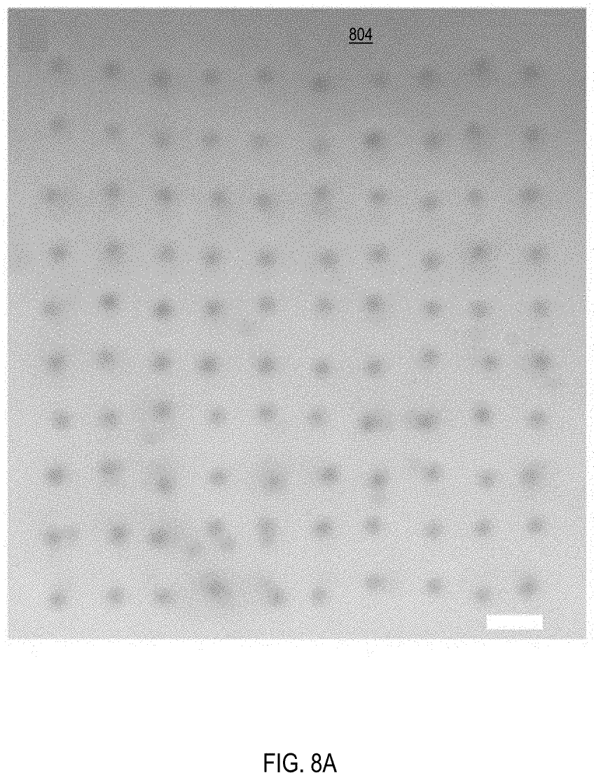

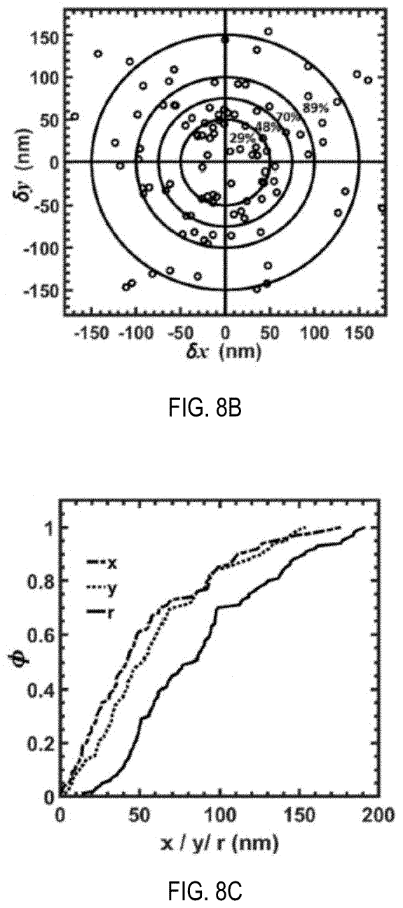

A 10×10 array of 100 nm AuNPs is printed on a glass receiving substrate 808 by using the OTM-NP, as shown in FIG. 8A. A laser intensity of 100 mW/μm2 and a gap of ˜1 μm between a donor substrate (not shown in FIG. 8A) and a receiver substrate are used. FIG. 8B shows a scatter plot of the printing error in x and y dimensions (transverse to the laser propagation direction). The printing error of each particle is evaluated by calculating a deviation of the center of mass of the image of the ith printed particle (xᵢ, yᵢ) from a targeted position (xᵢ₀, yᵢ₀). Therefore, the printing errors along xᵢ, yᵢ, and the radial r direction for the ith nanoparticle are (∂xi, ∂y, ∂r)=(xᵢ−xᵢ₀, yᵢ−yᵢ₀, (∂xᵢ²+∂yᵢ²)^{1/2}), respectively. The concentric circles in FIG. 8B represent printing errors of 50, 75, 100, and 150 nm and show that 29%, 48%, 70%, and 89% particles are printed within printing errors of 50, 75, 100, and 150 nm, respectively. According to FIG. 8B, 70% of the particles are printed with sub-100 nm accuracy. An alternative way of illustrating the printing accuracy and error is the cumulative probability distribution function φ of the printing, which represents the probability that a nanoparticle will be printed within a certain range from the target position. FIG. 8C shows the 1D cumulative probability distribution functions φ(x), φ(y), and φ(r). The standard deviations of the printing error in the x, y, and radial r directions are Sₓ=68 nm, S_{y}=71 nm, and Sᵣ=99 nm, respectively. Higher printing accuracy has been achieved in the additive printing of one, two, three, four, and ten individual AuNPs at the same positions on a receiver substrate as shown in FIG. 1F and inset of FIG. 1A, respectively. The printing accuracy of the OTM-NP method is affected by the parameters such as the homogeneity of donor substrate, nanoparticle shape, laser polarization, optical force, and the gap between the donor and receiver substrates. In comparison, the printing accuracy of the LIFT/LIBT is affected by parameters such as film thickness, laser focal spot size, laser pulse energy, and laser wavelength. In addition, the size of the printed nanoparticles with LIFT/LIBT is comparatively larger than that with OTM-NP, because the HAZ in LIFT/LIBT depends on the size of the diffraction-limited laser focal spot. In contrast, the HAZ in OTM-NP depends on the size of the AuNP, which can be smaller than that in LIFT/LIBT.

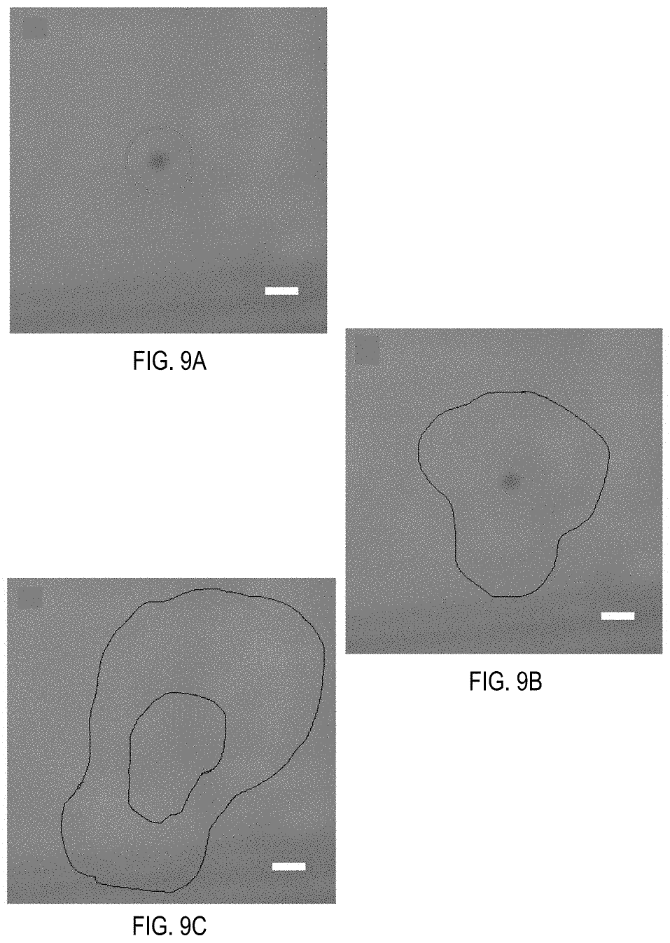

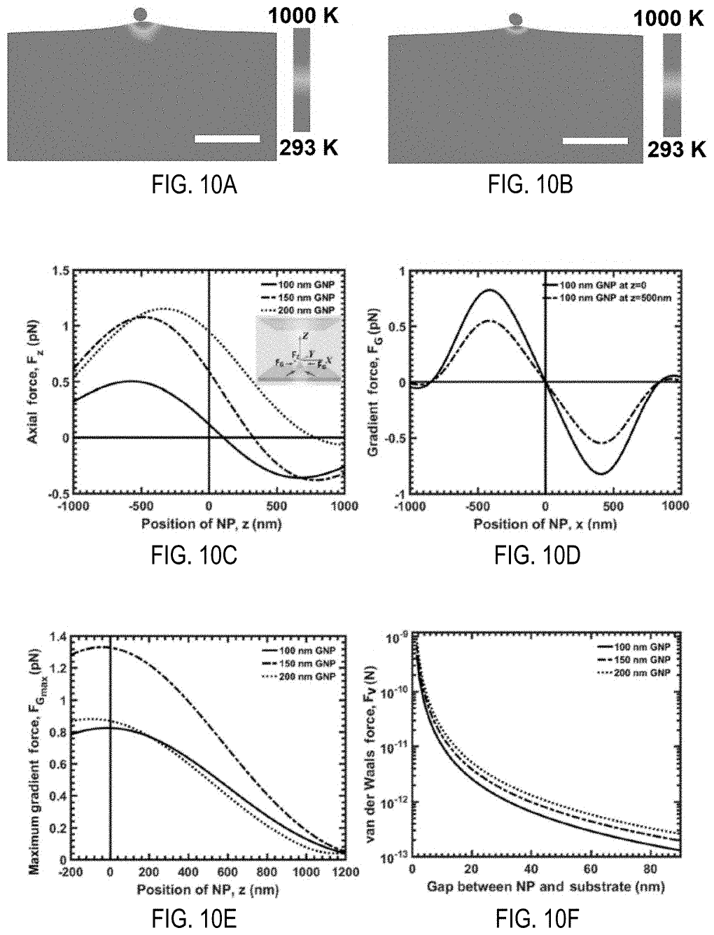

The homogeneity of the donor substrate is important for symmetric heat conduction and thermal expansion around the nanoparticle. Symmetric thermal expansion around a spherical nanoparticle provides the nanoparticle with a momentum normal to the donor substrate's surface. Therefore, it helps to transfer the nanoparticle vertically toward the target position on the receiver substrate. In contrast, an asymmetric thermal expansion causes the nanoparticle to release with an angle to the surface normal, resulting in a printing error. FIGS. 9A-C show an asymmetric thermal expansion of a donor substrate around the AuNP due to the inhomogeneity of the donor substrate. FIG. 10A shows the simulated temperature distribution of an inhomogeneous PDMS substrate as a result of heating a 100 nm spherical AuNP. The position of the maximum expansion of the substrate surface, where the thermal expansion force is exerted on the nanoparticle, is not aligned with the center-of-mass of the AuNP. Therefore, the AuNP will be released at an angle to the normal of the donor substrate's surface. In contrast, the heating of a homogeneous substrate will allow the release of the AuNP normal to the surface (see FIG. 1G). An example homogenous PDMS coated substrate can be made by preparing a PDMS solution by adding a curing agent to an elastomer base of Dow SYLGARD 184 in a 1:10 (w/w) ratio. To achieve homogeneous PDMS film, the solution should be mixed thoroughly by a magnetic stirrer inside an airtight flask (e.g., for ten hours) and sonicated (e.g., for thirty minutes). A ˜10 μm thick homogeneous PDMS layer is then spin-coated on a glass coverslip at a spin speed of 7000 revolutions per minute for one minute.

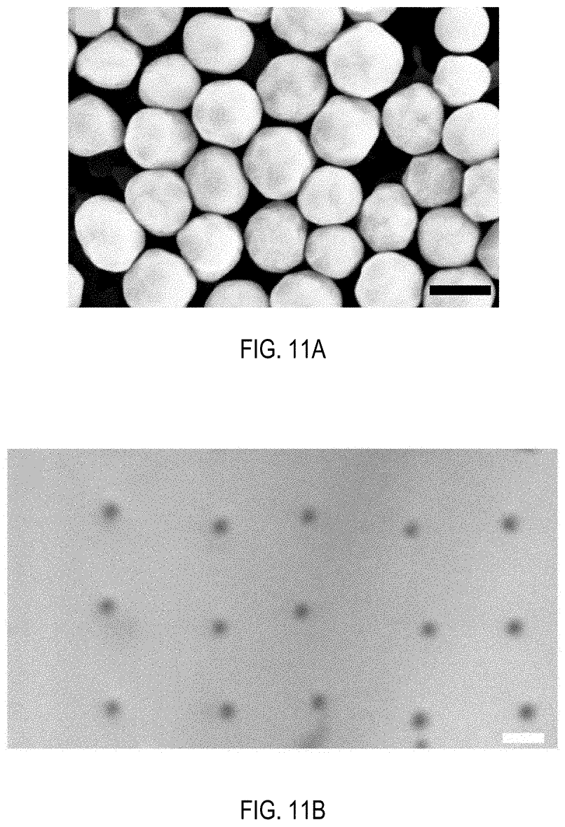

While the methods disclosed herein can be used for successful printing of 100 nm ultrauniform spherical AuNPs with sub-100 nm accuracy, it is challenging to print 200 nm imperfect spherical AuNPs (see FIG. 11A) with such accuracy. 200 nm AuNP usually have an imperfect spherical shape, which causes asymmetric temperature distribution in a donor substrate and misalignment between the maximum thermal expansion position and the center-of mass of the AuNP. FIG. 10B shows a simulation of temperature distribution and thermal expansion of a PDMS substrate as a result of heating of an elliptical AuNP. Moreover, the air drag force on an imperfect spherical nanoparticle also affects the trajectory of the nanoparticle in the transfer process. However, the printing accuracy of imperfect spherical 200 nm AuNPs can be significantly improved by preheating. In the preheating technique, a 200 nm AuNP is first preheated with a laser intensity of 4 mW/μm², and then the laser intensity is quickly increased to 11 mW/μm² to desorb the AuNP from the donor substrate. One possible reason for the improvement of printing accuracy with preheating is that the preheating helps to round the edges of the imperfect spherical AuNP and makes it comparatively more spherical. AuNP shrinks after preheating and looks more spherical. A 5×3 array of 200 nm AuNPs is printed by using the preheating technique (see FIG. 11B).

The use of a circularly polarized laser beam can further improve the printing accuracy. For example, a quarter wave plate is used to convert the laser polarization from linear to circular, which provides a symmetric focal spot because of a reduced depolarization of the oil-immersion objective. The focal spot of a linearly polarized laser beam from an oil-immersion objective lens is elongated in the direction of the laser polarization. The symmetric focal spot helps in symmetric temperature distribution around the nanoparticle that results in higher printing accuracy.

Illuminating a AuNP with a focused laser beam not only increases the temperature of the AuNP but also exerts an optical force on the AuNP, which can improve the printing accuracy. FIGS. 10C-D represent the calculated optical axial forces (Fz) and transverse optical gradient force (F_{G}) on a 100, 150, and 200 nm AuNP, respectively. The optical forces (Fz, F_{G}) exerted on a AuNP with a size ranging from 100 to 200 nm is on the order of pico-Newtons (pN) depending on the laser power. The van der Waals force between a PDMS substrate and a AuNP with a size ranging from 100 to 200 nm is on the order of nano-Newton (nN) depending on the gap between the nanoparticle and substrate's surface (see FIG. 10F). Therefore, a AuNP cannot be released from a PDMS donor substrate by only the optical force. The van der Waals attractive force dominates until the AuNP leaves the substrate. Once the AuNP leaves the donor substrate due to the thermal expansion force, the optical force can be used to improve the printing accuracy. FIG. 10E shows the maximum transverse optical gradient force (FGₘₐₓ) for a 100, 150, and 200 nm AuNP as the AuNP moves toward the receiver substrate in the z direction. The AuNP experiences higher FGₘₐₓ around the focal plane (z=0 in FIG. 10E). Therefore, focusing the laser beam a few hundred nanometers above the AuNP helps to decrease the spreading angle of the AuNP as it moves toward the receiver substrate. Sub-100 nm printing accuracy has been achieved by focusing a laser beam slightly above the AuNP.

The gap between the donor and receiver substrates also has a direct effect on the printing accuracy. A smaller gap reduces the printing error because the amount of deviation of the landed particle from its targeted position on the receiver substrate is directly proportional to the gap distance between the donor and receiver substrates. The gap was kept at ˜1 μm in our experiments unless stated otherwise.

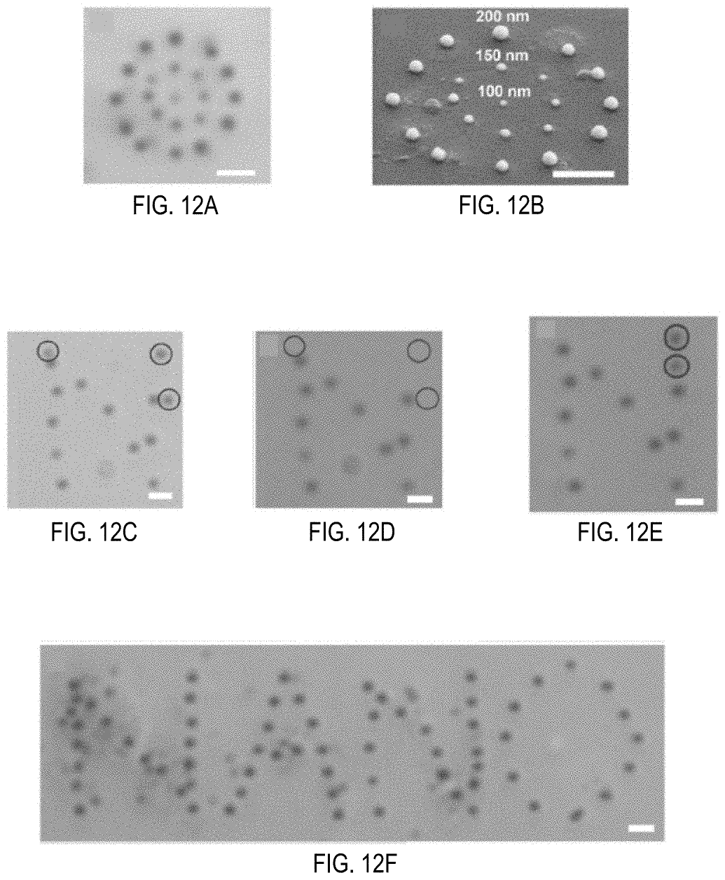

The wide variety of commercially available nanoparticles provides an affordable and unlimited supply of raw materials for the OTM-NP. Nanoprinting can be realized by either additively printing the same size (FIG. 1E-F) or selectively printing different sizes of nanoparticles (FIG. 12A-B). FIG. 12A-B represents an optical image (FIG. 12A) and a SEM image (FIG. 12B) of a circular structure that is printed on a glass substrate by printing one 100 nm AuNP at the center, eight 150 nm AuNPs in the first ring, and twelve 200 nm AuNPs in the second ring. The laser intensities used for the printing of 100, 150, and 200 nm AuNPs are 100 mW/μm², 40 mW/μm², and 11 mW/μm², respectively.

The desorption process of the OTM-NP can also be used to correct printing errors for nanorepairing as shown in FIG. 12C-E. The letter “N” is first printed by additive printing of fourteen 200 nm AuNPs on an ITO-coated glass substrate with preheating (FIG. 12C). To repair the pattern “N”, three AuNPs (marked in the circles) are selectively removed from the letter (FIG. 12D). Then two new AuNPs (marked in the circles) are added to the letter “N” to repair the structure as shown in FIG. 12E. Both the nanoprinting and the nanorepairing can be conducted on the same platform under ambient conditions. FIG. 12F shows the optical image of the word “NANO” comprising 200 nm AuNPs that are printed and corrected by using the OTM-NP and the nanorepairing technique

In conclusion, an affordable OTM-NP method that allows for both additive nanoprinting and nanorepairing with sub-100 nm accuracy has been successfully demonstrated. The working mechanism and guidelines for improving the printing accuracy are discussed in detail. This method has the following unique features: First, the OTM-NP is accomplished in the air with a CW laser, which allows for rapid and affordable prototyping of nanoscale structures without contaminating the receiver substrate. In contrast, optical printing based on optical forces requires a liquid environment. Laser-induced forward/backward transfer (LIFT/LIBT) methods are realized in gaseous environments, but expensive pulsed lasers are required. Second, the OTM-NP can print nanoparticles of different types and sizes in sequence either to form 2D structures or merge the nanoparticles to form structures in a direction that is normal to the printing substrate. Therefore, this technique can be potentially used for the fabrication of 2D and 3D electronic and optical devices such as metasurface or even 3D metamaterial. Finally, it can be potentially used as a nanorepairing tool to correct printing errors that are inevitable and challenging to correct.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The flowcharts, block diagrams, and schematic diagrams in the Figures illustrate the architecture, functionality, and operation of possible implementations of systems, methods and computer program products according to various embodiments of the present disclosure. In this regard, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

What is claimed is:

1. A process for nanoprinting, the process comprising:
attaching a metallic nanoparticle on a flexible donor substrate;
positioning a receiver substrate proximate to the donor substrate
focusing a continuous-wave laser on the metallic nanoparticle to heat the donor substrate and supply energy to the metallic nanoparticle;
supplying enough energy to:
cause rapid thermal expansion of the donor substrate; and
supply optical axial force and optical gradient force to the metallic nanoparticle, wherein the thermal expansion, optical axial force, and optical gradient force release the metallic nanoparticle from the donor substrate;
focusing the laser above the metallic nanoparticle; and
receiving the metallic nanoparticle on the receiver substrate.

2. The process of claim 1, wherein attaching a metallic nanoparticle on a flexible donor substrate comprises attaching an gold nanoparticle on a flexible donor substrate.

3. An opto-thermomechanical (OTM) nanoprinting method, the method comprising:
illuminating a nanoparticle on a surface of a soft substrate by a continuous-wave (CW) laser beam until the laser heats the nanoparticle and induces a rapid thermal expansion of the soft substrate;
wherein, the thermal expansion releases a nanoparticle from the soft surface.

4. The method of claim 3, wherein the laser beam is illuminated in a gaseous environment.

5. The method of claim 3, wherein the thermal expansion is utilized for nanorepairing.

6. The method of claim 4, wherein nanorepairing is carried out under ambient conditions.

7. The method of claim 3, wherein the thermal expansion is utilized for transfers of the nanoparticle additively to another surface in the presence of optical forces for nanoprinting.

8. The method of claim 5 wherein the nanoprinting is carried out with sub-100 nm accuracy.

9. A process comprising:
diluting a nanoparticle solution;
drop-casting the diluted nanoparticle solution;
drying the solution on a donor substrate;
operating a continuous wave laser to focus a laser beam towards the donor substrate to release a nanoparticle
transferring the released nanoparticle; and
printing the transferred nanoparticle onto a receiver substrate.

10. The process of claim 9, wherein the doner substrate consists of a soft, thin layer.

11. The process of claim 10, wherein the thin layer comprises polydimethylsiloxane (PDMS) on a glass coverslip.

12. The process of claim 11, wherein the continuous wave laser is operated at 1064 nm.

13. The process of claim 9 further comprising using an oil-immersion objective to focus the laser beam.

14. The process of claim 9 further comprising utilizing an optical system to direct the laser beam as shown in FIG. 3.

15. The process of claim 9 further comprising:
targeting a nanoparticle brought to the laser focus by using a nanopositioning stage, while the laser beam is OFF; and
releasing the nanoparticle from the donor substrate when the laser is turned ON.
